(19) United States
(12) Patent Application Publication
(10) Pub. No.: US 2026/0322853 A1
(43) Pub. Date: Oct. 15, 2026

(54) AUTOMATIC REAL-TIME DETECTION AND MITIGATION OF REVERSE SHELL ATTACKS

(71) Applicant: Red Hat, Inc., Raleigh, NC (US)

(72) Inventors: Paolo Antinori, Milan (IT); Andrea Cosentino, Milan (IT)

(73) Assignee: Red Hat, Inc., Raleigh, NC (US)

(21) Appl. No.: 19/175,294

(22) Filed: Apr. 10, 2025

(51) Int. Cl. H04L 9/40; G06N 20/00

(52) U.S. Cl. CPC H04L 63/1466; H04L 63/1408; H04L 63/1491; G06N 20/00

(57) ABSTRACT

This application relates to automatic real-time detection and mitigation of reverse shell attacks. In some examples, a system can execute a machine-learning model to detect a reverse shell attempt by an attacker in relation to a target network machine in a computer network. In response to detecting the reverse shell attempt, the system can deploy a honeypot network machine in the computer network. The honeypot network machine can be configured to mimic the target network machine and can be sandboxed from a remainder of the computer network. The system can then redirect a connection of the attacker from the target network machine to the honeypot network machine. By redirecting the attacker to the sandboxed honeypot machine, the reverse shell attack can be mitigated.

### TECHNICAL FIELD

The present disclosure relates generally to cybersecurity. More specifically, but not by way of limitation, this disclosure relates to a system for automatic real-time detection and mitigation of reverse shell attacks.

### BACKGROUND

Reverse shell attacks are a form of cybersecurity threat in which an attacker gains unauthorized access to a target device by exploiting vulnerabilities to establish a remote connection. Unlike traditional shell attacks, where the attacker initiates a direct connection to the target device, a reverse shell attack causes the compromised device to initiate a connection back to the attacker’s system, bypassing typical network security measures such as firewalls and intrusion detection systems. This connection enables the attacker to execute commands, exfiltrate sensitive data, or deploy malicious software remotely. Reverse shell attacks are often facilitated through phishing emails, malware payloads, or exploitation of software vulnerabilities, and they pose significant risks to organizations by enabling unauthorized control over critical systems and networks.

### BRIEF DESCRIPTION OF THE DRAWINGS

FIG. 1 shows a block diagram of an example of a system for automatic real-time detection and mitigation of reverse shell attacks according to some aspects of the present disclosure.

FIG. 2 shows a block diagram of an example of a system for automatic real-time detection and mitigation of reverse shell attacks according to some aspects of the present disclosure.

FIG. 3 shows a flowchart of an example of a process for automatic real-time detection and mitigation of reverse shell attacks according to some aspects of the present disclosure.

### DETAILED DESCRIPTION

A reverse shell attack is a cybersecurity threat that involves an attacker causing a compromised device to initiate a connection with the attacker’s system. Because the compromised device initiates the connection, it is challenging to detect these kinds of attacks. Typical network security measures, such as firewalls and intrusion detection systems, normally analyze connections initiated by external devices rather than internal network devices, since they assume that connections initiated by internal network devices are intentional and legitimate. As a result, attackers can circumvent these typical network security measures with a reverse shell attack. This makes reverse shell attacks particularly difficult to detect and mitigate.

Some examples of the present disclosure can overcome one or more abovementioned problems by providing a system configured to automatically detect and mitigate reverse shell attacks in real time. The system can include a machine-learning model that is trained to detect reverse shell attempts. The system can execute the machine-learning model to automatically analyze network machines in real time for a reverse shell attempt. If the system detects a reverse shell attempt by an attacker with respect to a target network machine, the system can automatically deploy a honeypot network machine. The honeypot network machine can be configured to mimic the target network machine, except that the honeypot network machine is sandboxed (e.g., isolated) from a remainder of the computer network. The system can then redirect the attacker’s connection from the target network machine to the honeypot network machine, thereby disconnecting the attacker from the target network machine and connecting the attacker to the honeypot network machine. This can occur transparently, without the attacker’s knowledge. Because the honeypot network machine can mimic the target network machine, the attacker may not realize their connection has been transferred to the honeypot network machine. And because the honeypot network machine is sandboxed, the attacker’s access may be limited unbeknownst to the attacker, thereby mitigating the reverse shell attack.

After transferring the attacker to the honeypot network machine, in some examples the system can automatically monitor the actions of the attacker on the honeypot network machine. Through this process, the system can gather further intelligence about the attacker and the reverse shell threat. Using this additional intelligence, the system can further tune the machine-learning model to improve the model’s detection capabilities in the future. After gathering this intelligence, the system may automatically block the attacker from the computer network to help prevent harm to the network. For instance, the system can add an internet protocol (IP) address of the attacker to a block list.

In some examples, the system can perform a two-stage detection process to reduce the number of times the machine-learning model is executed, thereby reducing consumption of computing resources (e.g., memory and processing power). The first stage can occur before executing the machine-learning model. In the first stage, the system can perform an initial anomaly detection process with respect to a network machine. This can involve comparing current operational data for the network machine to a stored baseline operational profile for the network machine. If the system detects a functional anomaly based on this comparison, the system may then perform the second stage. In the second stage, the system can trigger the machine-learning model to evaluate the network machine for a potential reverse shell attack. By only triggering the machine-learning model after the initial anomaly detection, the system can reduce the resource consumption of the system.

Using the techniques described above, the system can automatically detect and mitigate reverse shell threats in their early stages, reducing the risk of damage and data breaches. By actively engaging with the attacker in a controlled environment (e.g., the honeypot machine), the system can further neutralize threats and protect valuable data. The system can also collect valuable threat intelligence, helping organizations understand attacker’s tactics, techniques, and procedures. This threat intelligence can also be used by the system to continually adapt and evolve, allowing the system to stay ahead of emerging threats. In this way, the system can provide a proactive and adaptive solution for modern cybersecurity challenges such as reverse shell attacks.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

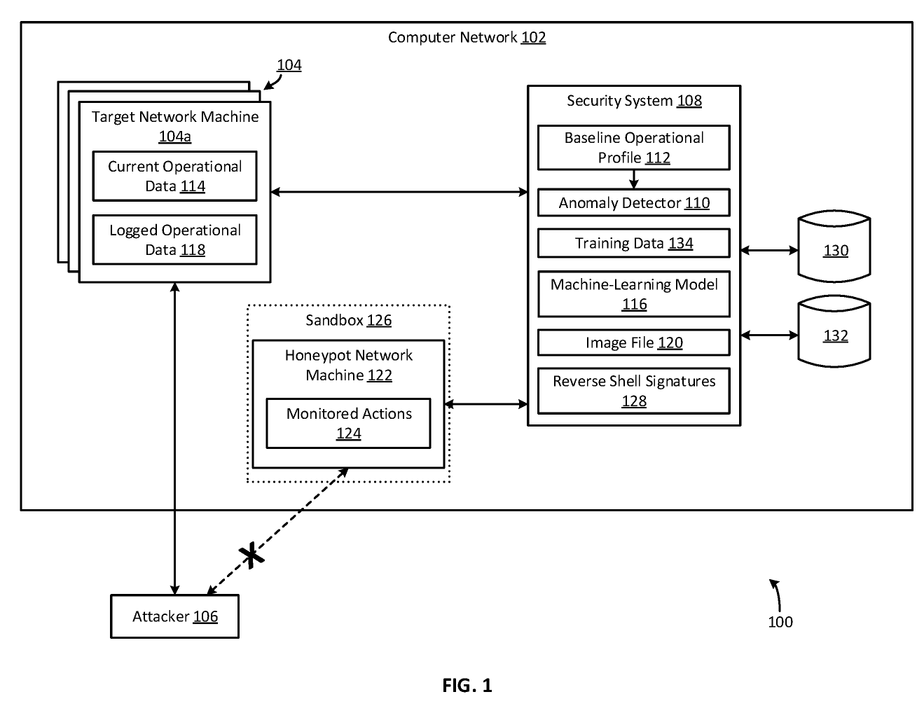

FIG. 1 shows a block diagram of an example of a system 100 for automatic real-time detection and mitigation of reverse shell attacks according to some aspects of the present disclosure. The system 100 includes a computer network 102. The computer network 102 may be a private network or a public network. In some examples, the computer network 102 may be a cloud computing system.

The computer network 102 can include any number of networked machines 104. The networked machines 104 may include physical machines and/or virtual machines. Examples of the networked machines 104 can include servers, desktop computers, laptop computers, tablets, Internet of Things (IOT) devices, wearable devices such as smart watches or headsets, mobile phones, or any combination of these.

In some examples, the computer network 102 may employ a security system 108. The security system 108 can include one or more physical machines, such as servers. It will be appreciated that although the security system 108 is shown in FIG. 1 as internal to the computer network 102, in other examples the security system 108 may be external to the computer network 102 and in communication with the network machines 104. For instance, the security system 108 may be provided as a subscription service by a third party that is unrelated to (e.g., does not own or operate) the computer network 102.

The security system 108 can communicate with each of the network machines 104 to collect baseline operational data for each of the network machines 104. For example, the security system 108 can communicate with the target network machine 104a to collect baseline operational data associated with the target network machine 104a. The baseline operational data can indicate normal operating conditions on the target network machine 104a when it is not under attack. Examples of the baseline operational data can include information about processor usage, memory usage, storage usage, and/or workload execution on the target network machine 104a. The baseline operational data can span a time window. For example, the baseline operational data can span one week, one month, or three months.

The security system 108 can generate a baseline operational profile for each of the network machines 104 based on its baseline operational data. For example, the security system 108 can generate a baseline operational profile 112 for the target network machine 104a based on its baseline operational data. In some examples, the baseline operational profile 112 may indicate averages of the collected baseline operational data for the target network machine 104a. For instance, the baseline operational profile 112 may indicate average processor usage, average memory usage, and average workloads over the time window. The security system 108 can store the baseline operational profiles for the network machines 104 in a datastore 130, such as a database.

The security system 108 can use the baseline operational profiles for the network machines 104 to automatically monitor them for anomalous activity. For example, the security system 108 can include an anomaly detector 110 that can periodically collect current operational data 114 from the target network machine 104a. The current operational data 114 can include real-time information about processor usage, memory usage, storage usage, and/or workloads on the target network machine 104a. In some examples, the current operational data 114 can span a recent time window, such as the last 30 minutes. The anomaly detector 110 can compare the current operational data 114 for the target network machine 104a to its baseline operational profile 112 to detect differences between the two. If the anomaly detector 110 detects a large enough difference between the two, this may suggest an anomalous condition. For example, the anomaly detector 110 can determine whether there is at least a threshold difference between current processor usage and the baseline processor usage. If so, the anomaly detector 110 can detect an anomaly on the target network machine 104a. The security system 108 can periodically perform this anomaly detection process with respect to each of the network machines 104 to monitor them for potential anomalies.

Under normal operating conditions, the security system 108 may not detect any anomalies. But at some point in time, an attacker 106 (e.g., an attacker system) may establish a connection to the target network machine 104a and attempt to perform a reverse shell attack on the target network machine 104a. To that end, the attacker 106 may issue various commands or try to install malicious software to execute the reverse shell attack. This may cause one or more of the current operating conditions on the target network machine 104a to be sufficiently different from its baseline operational profile 112 to trigger a detection by the anomaly detector 110.

If the security system 108 detects (e.g., via anomaly detector 110) an anomaly with respect to the target network machine 104a, the security system 108 may perform a more comprehensive analysis of the activity on the target network machine 104a using a machine-learning model 116. Examples of the machine-learning model 116 can include a neural network or classifier, such as a decision tree, Naive Bayes classifier, Support Vector Machine (SVM), Random Forest classifier, or Logistic Regression classifier. In some examples, the machine-learning model 116 may include an ensemble of models. The machine-learning model 116 can be different from the anomaly detector 110.

The machine-learning model 116 may have been previously trained using training data 134. This can transform the machine-learning model 116 from an untrained state to a trained state by tuning weights assigned to its internal nodes. In some examples, the training data 134 can include a predefined set of reverse shell signatures. A reverse shell signature can be an event or sequence of events indicative of an impending reverse shell attack. For instance, a reverse shell signature may include a series of system commands design to exploit a vulnerability or elevate privileges in a way that often precedes a reverse shell attack. The training data 134 may have been created by security professionals based on their experience and expertise with reverse shell attacks. Upon training the machine-learning model 116, the machine-learning model 116 can learn which events and sequences of events are highly suggestive of an ongoing or impending reverse shell attack.

To use the machine-learning model 116, the security system 108 can collect logged operational data 118 associated with the target network machine 104a. The security system 108 can then provide the logged operational data 118 as input to the machine-learning model 116. The logged operational data 118 may be operational data that is stored in one or more logs on the target network machine 104a. Examples of the logged operational data 118 may include information about network traffic, application execution, system commands, or other activity on the target network machine 104a. In some examples, the logged operational data 118 can include the current operational data 114. The machine-learning model 116 can receive the logged operational data 118 and analyze the logged operational data 118 for a reverse shell signature. If the machine-learning model 116 identifies a reverse shell signature in the logged operational data 118, the machine-learning model 116 can generate an output indicating that it detected a reverse shell attempt.

In response to the machine-learning model 116 detecting a reverse shell attempt, the security system 108 can automatically deploy a honeypot network machine 122. For example, the security system 108 can interface with an application programming interface (API) of the computer network 102 to provision the honeypot network machine 122. Additionally or alternatively, the security system 108 may automatically alert an administrator about the reverse shell attempt. For example, the security system 108 can transmit a notification of the reverse shell attempt to a user device (e.g., a mobile device or desktop computer) of the administrator.

To effectively deceive the attacker 106, the honeypot network machine 122 can be configured to mimic the target network machine 104a. For example, the honeypot network machine 122 can be configured to closely replicate the operational, software, hardware, and/or network characteristics of the target network machine 104a. This mimicry can help maintain the illusion of authenticity.

To mimic the target network machine 104a, in some examples the honeypot network machine 122 can be provisioned with an identical or near-identical software configuration as the target network machine 104a, including the same operating system, filesystem structure, installed applications, network services, and user accounts. Additionally, the honeypot network machine 122 can replicate the hardware specifications of the target network machine 104a, such as processor cores, RAM allocation, and storage capacity, ensuring that the attacker 106 perceives the honeypot network machine 122 as the original target machine 104a. Network configurations, including IP address, MAC address, and hostname, can also be mirrored to enhance the authenticity of the honeypot network machine 122 and avoid raising suspicion.

In some examples, the security system 108 can deploy the honeypot network machine 122 using the same image file 120 that was used to deploy the target network machine 104a. This approach ensures that the honeypot network machine 122 is virtually identical to the target network machine 104a, whether the target network machine 104a is a virtual machine, a container, or a physical device. For example, if the target network machine 104a is deployed as a virtual machine using a hypervisor, the honeypot network machine 122 can be instantiated from the same virtual machine image file. Similarly, if the target network machine 104a is a container deployed using a container engine (e.g., Podman or Docker®), the honeypot network machine 122 can be created using the same container image file. This duplication of deployment methods helps maintain consistency between the two systems and ensures that the honeypot network machine 122 can convincingly substitute for the target network machine 104a.

Additionally, the honeypot network machine 122 may be configured to simulate the behavior of the target network machine 104a under attack. For instance, the honeypot network machine 122 can respond to commands issued by the attacker 106 in ways that mimic the expected responses of the target network machine 104a. It can simulate file access, resource usage, and network communication patterns that mirror the target network machine’s 104a typical operational behavior. This dynamic mimicry can include generating fake data responses, imitating latency patterns, or simulating the execution of applications to further convince the attacker 106 that they are interacting with the original target machine 104a. By replicating these behaviors, the honeypot network machine 122 can prolong the attacker’s engagement, allowing the security system 108 to gather intelligence about the attacker’s 106 methods and intentions.

In some examples, the honeypot network machine 122 can be sandboxed 126 from a remainder of the computer network 102, ensuring that any actions performed by an attacker 106 on the honeypot network machine cannot affect other systems within the computer network 102. This sandboxing 126 can ensure that even if the attacker 106 attempts to deploy malicious software or escalate privileges, their actions remain confined to the honeypot environment and cannot propagate to other parts of the computer network 102. This containment provides an additional layer of security while enabling the collection of valuable threat intelligence. The attacker 106 remains unaware of the deception, as the honeypot machine’s 112 mimicry is designed to be indistinguishable from the original target machine 104a, thus mitigating the reverse shell attack while preserving the integrity of the computer network 102.

After deploying the honeypot network machine 122, the security system 108 can redirect (e.g., forward) the attacker’s connection to the honeypot network machine 122. To achieve this, the security system 108 can interface with network infrastructure components such as routers, switches, hubs, and software-defined networking (SDN) controllers, as well as network security tools like firewalls and intrusion detection/prevention systems (IDS/IPS). By manipulating routing tables, packet forwarding rules, or firewall configurations, the computer network 102 can seamlessly reroute traffic originating from the attacker 106 to the honeypot network machine 122.

The redirection process can occur transparently, so that the attacker 106 remains unaware that their connection has been rerouted from the target network machine 104a to the honeypot network machine 122. This transparency can be achieved by preserving key network attributes during the redirection, such as IP addresses, port numbers, and session identifiers. By maintaining these attributes, the attacker 106 may perceive the honeypot network machine 122 as the original target machine 104a and continue their malicious activity without suspicion. This transparency not only prevents the attacker 106 from realizing their connection has been redirected to a decoy system but also promotes continuity in the attacker’s operations, allowing the security system 108 to gather valuable intelligence on the attacker’s tactics, techniques, and procedures (TTPs).

In FIG. 1, the redirection process is illustrated by the dashed arrow, which represents the transfer of the connection from the target network machine 104a to the honeypot network machine 122. Following this redirection, the connection between the attacker 106 and the target network machine 104a is terminated, effectively severing the attacker’s access to the legitimate network machine. At the same time, a new connection is established between the attacker 106 and the honeypot network machine 122. This ensures that the attacker’s malicious activity is confined to the sandboxed environment of the honeypot network machine 122, thereby preventing any potential harm to the computer network 102 and its components.

After redirection, the security system 108 can monitor the attacker’s actions 124 on the honeypot network machine 122. To that end, monitoring tools and logging mechanisms may be deployed (e.g., by the security system 108) within the honeypot network machine 122 to monitor the attacker’s actions 124. Through this monitoring, the security system 108 can capture detailed information about the attacker’s behavior, including executed commands, attempted privilege escalations, and deployed malware.

In some examples, the security system 108 can leverage the intelligence gathered from monitoring the attacker’s actions 124 on the honeypot network machine 122 to refine and optimize the machine-learning model 116 for future detection of reverse shell attacks. This refinement process, known as “tuning”, involves adapting the machine-learning model 116 to better recognize patterns, behaviors, and signatures associated with reverse shell attempts. Specifically, the security system 108 can analyze the monitored actions 124 to identify novel attack vectors, command sequences, or techniques employed by the attacker 106 that may not have been part of the machine-learning model’s initial training data. These insights can be used to generate one or more new reverse shell signatures 128 or update existing ones.

One approach to tuning the machine-learning model 116 involves retraining it using the newly identified reverse shell signatures 128 derived from the attacker’s behavior. For instance, the security system 108 can compile a dataset of the attacker’s monitored actions, including any anomalous commands, privilege escalation attempts, or malware deployment strategies observed during their interaction with the honeypot network machine 122. This dataset can then be fed into the machine-learning model 116 as additional training data. During the retraining process, the machine-learning model 116 adjusts its internal weights and parameters to incorporate these new patterns, thereby enhancing its ability to detect similar threats in the future.

Another approach to tuning the machine-learning model 116 involves storing the newly identified reverse shell signatures 128 in a datastore 132, such as a database of reverse shell signatures, which the machine-learning model 116 may rely on during real-time analysis. In some examples, the datastore 132 may be a vector database and the reverse shell signatures 128 may be stored therein in a vectorized format (e.g., as numerical vector embeddings). By maintaining an up-to-date repository of reverse shell signatures, the system ensures that the machine-learning model 116 remains effective against emerging threats. The datastore 132 may also serve as a centralized resource for sharing threat intelligence across different systems or networks, allowing organizations to collaboratively improve their cybersecurity defenses.

By dynamically tuning the machine-learning model 116 based on real-world attacker behavior, the security system 108 not only mitigates the immediate threat posed by the reverse shell attack but also creates a feedback loop for continuous improvement. This adaptive approach allows the system to evolve alongside emerging cybersecurity challenges, ensuring that it remains effective against increasingly sophisticated threats. Furthermore, this iterative refinement process enhances the security system’s 108 ability to detect and respond to reverse shell attacks in their early stages, reducing the likelihood of successful data breaches or system compromise.

Eventually, the security system 108 may automatically sever the attacker’s connection to the honeypot network machine 122. This severing process is represented by the “X” on the dashed arrow in FIG. 1. For instance, the security system 108 may sever the attacker’s connection after gathering sufficient intelligence by monitoring the honeypot network machine 122. The security system 108 may also block the attacker 106 from further connecting to the computer network 102 to help prevent harm. For instance, the security system 108 can interface with network infrastructure components and/or network security tools to sever the attacker’s connection and add the attacker’s IP address to a block list.

After the security system 108 severs the attacker’s connection to the honeypot network machine 122, the honeypot network machine 122 may no longer be needed. So, the security system 108 can shut down the honeypot network machine 122. For example, the security system 108 can interface with an API of the computer network 102 to shut down the honeypot network machine 122. This can help conserve computing resources.

Using the techniques described above, the security system 108 not only mitigates the immediate threat posed by the reverse shell attack but also creates an opportunity to study the attacker’s methods and gather actionable intelligence. This proactive approach enables organizations to strengthen their defenses against similar threats in the future while safeguarding their critical systems and data.

It will be appreciated that although various examples are described herein with respect to a reverse shell attack, similar principles can be applied to other types of cyberattacks. Thus, the present disclosure is not intended to be limited to only reverse shell attacks and may be modified to detect and mitigate other types of cyberattacks.

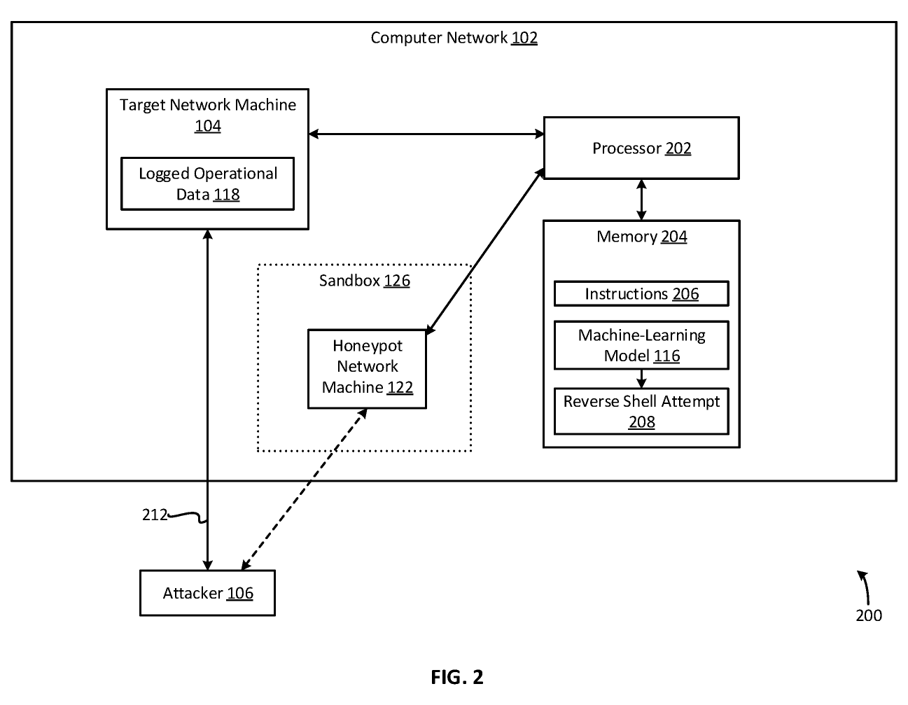

FIG. 2 shows a block diagram of an example of a system 200 for automatic real-time detection and mitigation of reverse shell attacks according to some aspects of the present disclosure. The system 200 includes a processor 202 communicatively coupled to a memory 204. In some examples, the processor 202 and memory 204 may be located in the same physical device, such as a server. In other examples, the processor 202 and memory 204 may be located in different physical devices (e.g., distributed from one another) and communicatively coupled to one another.

The processor 202 can include one processing device or multiple processing devices. Non-limiting examples of the processor 202 include a Field-Programmable Gate Array (FPGA), an application-specific integrated circuit (ASIC), a microprocessor, or any combination of these. The processor 202 can execute instructions 206 stored in the memory 204 to perform operations, such as any of the operations described above with respect to the security system 108 of FIG. 1. In some examples, the instructions 206 can include processor-specific instructions generated by a compiler or an interpreter from code written in any suitable computer-programming language, such as C, C++, C#, Python, or Java.

The memory 204 can include one memory device or multiple memory devices. The memory 204 can be volatile or non-volatile, such that the memory 204 retains stored information when powered off. Non-limiting examples of the memory 204 include electrically erasable and programmable read-only memory (EEPROM), flash memory, or any other type of non-volatile memory. At least some of the memory device can include a non-transitory computer-readable medium from which the processor 202 can read the instructions 206. A computer-readable medium can include electronic, optical, magnetic, or other storage devices capable of providing the processor 202 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 206.

In some examples, the processor 202 can execute the instructions 206 to perform one or more operations. For example, the processor 202 can execute a machine-learning model 116 to detect a reverse shell attempt 208 by an attacker 106 in relation to a target network machine 104 in a computer network 102. The machine-learning model 116 can be configured to detect the reverse shell attempt 208 by analyzing logged operational data 118 for the target network machine 104 for a reverse shell signature. In response to detecting the reverse shell attempt 208, the processor 202 can deploy a honeypot network machine 122 in the computer network 102. The honeypot network machine 122 can be configured to mimic the target network machine 104. The honeypot network machine 122 may be sandboxed 126 from a remainder of the computer network 102. Based on deploying the honeypot network machine 122, the processor 202 can redirect a connection 212 of the attacker 106 from the target network machine 104 to the honeypot network machine 122. Through this redirection, the attacker 106 can be disconnected from the target network machine 104 and connected to the honeypot network machine 122.

In some examples, the processor 202 can monitor actions of the attacker 106 on the honeypot network machine 122. Based on the monitored actions of the attacker 106 on the honeypot network machine 122, the processor 202 can tune the machine-learning model 116 (e.g., to thereby generate a tuned machine-learning model). Through this feedback loop, the machine-learning model’s ability to detect reverse shell attacks can continually improve over time.

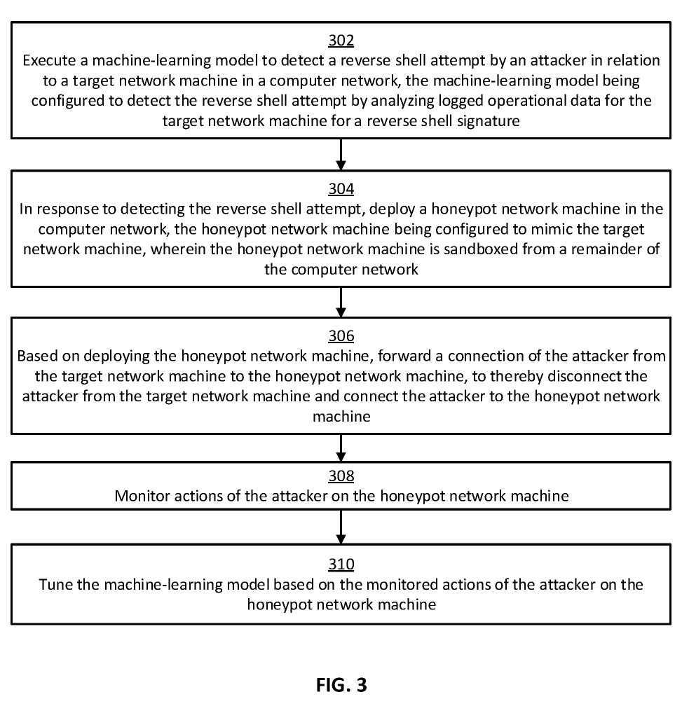

Turning now to FIG. 3, shown is a flowchart of an example of a process for automatic real-time detection and mitigation of reverse shell attacks according to some aspects of the present disclosure. Other examples may involve more operations, fewer operations, different operations, or a different sequence of operations than is shown in FIG. 3. The operations of FIG. 3 are described below with reference to the components of FIG. 2 described above.

In block 302, the processor 202 executes a machine-learning model 116 to detect a reverse shell attempt 208 by an attacker 106 in relation to a target network machine 104 in a computer network 102. The machine-learning model 116 can be configured to detect the reverse shell attempt 208 by analyzing logged operational data 118 for the target network machine 104 for a reverse shell signature. For instance, the machine-learning model 116 may have been previously trained based on a set of reverse shell signatures to learn activity patterns indicative of an ongoing or impending reverse shell attack.

In block 304, in response to detecting the reverse shell attempt 208, the processor 202 deploys a honeypot network machine 122 in the computer network 102. The honeypot network machine 122 can be configured to mimic the target network machine 104. The honeypot network machine 122 can be sandboxed 126 from a remainder of the computer network 102. The processor 202 can deploy the honeypot network machine 122 by transmitting commands to an API of the computer network 102 and/or interacting with other network components, which in turn can facilitate deployment of the honeypot network machine 122 in the computer network 102.

In block 306, based on deploying the honeypot network machine 122, the processor 202 redirects a connection 212 of the attacker 106 from the target network machine 104 to the honeypot network machine 122. The processor 202 can redirect the connection 212 by transmitting commands to an API of the computer network 102 and/or interacting with other network components, which in turn can facilitate the redirection of the connection 212 through the computer network 102. As a result of this redirection, the attacker 106 can be disconnected from the target network machine 104 and connected to the honeypot network machine 122.

In block 308, the processor 202 monitors actions 124 of the attacker 106 on the honeypot network machine 122. For example, the processor 202 can deploy monitoring tools on the honeypot network machine 122 to track the attacker’s activity. The processor 202 can then periodically communicate with those tools to receive details about the attacker’s activity on the honeypot network machine 122.

In block 310, based on the monitored actions 124 of the attacker 106 on the honeypot network machine 122, the processor 202 tunes the machine-learning model 116. For example, the processor 202 can derive information (e.g., a reverse shell signature or other insights) from the monitored actions 124 by analyzing the monitored actions 124. Based on that derived information, the processor 202 can further train the machine-learning model 116 or update a datastore 132 relied upon by the machine-learning model 116 in performing its operations.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code that is executable by one or more processors for causing the one or more processors to perform operations including:
executing a machine-learning model to detect a reverse shell attempt by an attacker in relation to a target network machine in a computer network, wherein the machine-learning model is configured to detect the reverse shell attempt by analyzing logged operational data for the target network machine for a reverse shell signature;
in response to detecting the reverse shell attempt, deploying a honeypot network machine in the computer network, the honeypot network machine being configured to mimic the target network machine, wherein the honeypot network machine is sandboxed from a remainder of the computer network; and
based on deploying the honeypot network machine, redirecting a connection of the attacker from the target network machine to the honeypot network machine, to thereby disconnect the attacker from the target network machine and connect the attacker to the honeypot network machine.

2. The non-transitory computer-readable medium of claim 1, wherein the connection is transparently redirected from the target network machine to the honeypot network machine to render the attacker unaware of a change in the connection.

3. The non-transitory computer-readable medium of claim 1, wherein the operations further comprise:
deploying the honeypot network machine from a same image file as the target network machine for causing the honeypot network machine to mimic the target network machine.

4. The non-transitory computer-readable medium of claim 3, wherein the image file is a virtual machine image file or a container image file.

5. The non-transitory computer-readable medium of claim 1, wherein the operations further comprise:
monitoring actions of the attacker on the honeypot network machine; and
tuning the machine-learning model based on the monitored actions of the attacker on the honeypot network machine.

6. The non-transitory computer-readable medium of claim 5, wherein the operation of further tuning the machine-learning model comprises:
deriving one or more reverse shell signatures based on the monitored actions of the attacker on the honeypot network machine; and
further training the machine-learning model based on the one or more reverse shell signatures.

7. The non-transitory computer-readable medium of claim 5, wherein the operation of further tuning the machine-learning model comprises:
deriving one or more reverse shell signatures based on the monitored actions of the attacker on the honeypot network machine; and
updating a database to store the one or more reverse shell signatures, the machine-learning model being configured to use a plurality of reverse shell signatures stored in the database to detect reverse shell attempts in network devices.

8. The non-transitory computer-readable medium of claim 5, wherein the operations further comprise:
based on detecting the reverse shell attempt, and subsequent to monitoring the actions of the attacker on the target network machine, blocking the attacker from the computer network.

9. The non-transitory computer-readable medium of claim 1, wherein the operations further comprise:
training the machine-learning model based on a training dataset that includes a plurality of reverse shell signatures, wherein training the machine-learning model transforms the machine-learning model from an untrained state to a trained state by adjusting weights of nodes in the machine-learning model.

10. The non-transitory computer-readable medium of claim 1, wherein the operations further comprise:
detecting a functional anomaly in relation to the target network machine by comparing current operational data of the target network machine to a baseline operational profile for the target network machine; and
based on detecting the functional anomaly in relation to the target network machine, executing the machine-learning model to determine whether the functional anomaly is associated with a reverse shell attempt on the target network machine.

11. A method comprising:
executing, by one or more processors, a machine-learning model to detect a reverse shell attempt by an attacker in relation to a target network machine in a computer network, wherein the machine-learning model is configured to detect the reverse shell attempt by analyzing logged operational data for the target network machine for a reverse shell signature;
in response to detecting the reverse shell attempt, deploying, by the one or more processors, a honeypot network machine in the computer network, the honeypot network machine being configured to mimic the target network machine, wherein the honeypot network machine is sandboxed from a remainder of the computer network; and
based on deploying the honeypot network machine, redirecting, by the one or more processors, a connection of the attacker from the target network machine to the honeypot network machine, to thereby disconnect the attacker from the target network machine and connect the attacker to the honeypot network machine.

12. The method of claim 11, wherein the connection is transparently redirected from the target network machine to the honeypot network machine to render the attacker unaware of a change in the connection.

13. The method of claim 11, wherein the target network machine and the honeypot network machine are virtual machines.

14. The method of claim 11, further comprising:
monitoring, by the one or more processors, actions of the attacker on the honeypot network machine; and
tuning, by the one or more processors, the machine-learning model based on the monitored actions of the attacker on the honeypot network machine.

15. The method of claim 14, wherein the operation of further tuning the machine-learning model comprises:
deriving one or more reverse shell signatures based on the monitored actions of the attacker on the honeypot network machine; and
further training the machine-learning model based on the one or more reverse shell signatures.

16. The method of claim 14, wherein the operation of further tuning the machine-learning model comprises:
deriving one or more reverse shell signatures based on the monitored actions of the attacker on the honeypot network machine; and
updating a database to store the one or more reverse shell signatures, the machine-learning model being configured to use a plurality of reverse shell signatures stored in the database to detect reverse shell attempts in network devices.

17. The method of claim 14, further comprising:
based on detecting the reverse shell attempt, and subsequent to monitoring the actions of the attacker on the target network machine, blocking the attacker from the computer network.

18. The method of claim 11, further comprising:
training the machine-learning model based on a training dataset that includes a plurality of predefined reverse shell signatures, wherein training the machine-learning model transforms the machine-learning model from an untrained state to a trained state by adjusting weights of nodes in the machine-learning model.

19. The method of claim 11, further comprising:
detecting a functional anomaly in relation to the target network machine by comparing current operational data of the target network machine to a baseline operational profile for the target network machine; and
based on detecting the functional anomaly in relation to the target network machine, executing the machine-learning model based on the logged operational data to determine whether the functional anomaly is associated with a reverse shell attempt on the target network machine.

20. A system comprising:
one or more processors; and
one or more memories storing instructions that are executable by the one or more processors for causing the one or more processors to perform operations including:
executing a machine-learning model to detect a reverse shell attempt by an attacker in relation to a target network machine in a computer network, wherein the machine-learning model is configured to detect the reverse shell attempt by analyzing logged operational data for the target network machine for a reverse shell signature;
in response to detecting the reverse shell attempt, deploying a honeypot network machine in the computer network, the honeypot network machine being configured to mimic the target network machine, wherein the honeypot network machine is sandboxed from a remainder of the computer network; and
based on deploying the honeypot network machine, redirecting a connection of the attacker from the target network machine to the honeypot network machine, to thereby disconnect the attacker from the target network machine and connect the attacker to the honeypot network machine.
